(19) United States
(12) Patent Application Publication
(10) Pub. No.: US 2025/0384686 A1
(43) Pub. Date: Dec. 18, 2025

(54) INTELLIGENT DETECTION METHOD FOR FLOWER OPENING DEGREE IN JASMINE TEA SCENTING

(71) Applicants: Shandong Academy of Agricultural Sciences, Jinan (CN); Hangzhou Feilianda Intelligent Technology Co.,Ltd., Hangzhou (CN); HMEI machinery & Engineering Co., Hangzhou (CN)

(72) Inventors: Chunwang DONG, Jinan (CN); Zhiwei CHEN, Jinan (CN); Yongchao MU, Jinan (CN); Xuesong ZHU, Jinan (CN); Dongyun XU, Jinan (CN); Dandan QI, Jinan (CN); Yali SHI, Jinan (CN); Zhengrui TIAN, Jinan (CN); Xingmin ZHANG, Jinan (CN); Mengjie WANG, Jinan (CN); Zezhong DING, Jinan (CN); Mengqi GUO, Jinan (CN); Dewen WANG, Jinan (CN)

(73) Assignees: Shandong Academy of Agricultural Sciences, Jinan (CN); Hangzhou Feilianda Intelligent Technology Co.,Ltd., Hangzhou (CN); HMEI machinery & Engineering Co., Hangzhou (CN)

(21) Appl. No.: 19/241,498

(22) Filed: Jun. 18, 2025

(30) Foreign Application Priority Data
Jun. 18, 2024 (CN) 202410783847.5

(51) Int. Cl. G06V 20/10; G06V 10/10; G06V 10/764; G06V 10/774; G06V 10/776; G06V 20/70

(52) U.S. Cl. CPC G06V 20/188; G06V 10/16; G06V 10/764; G06V 10/7747; G06V 10/776; G06V 20/70

(57) ABSTRACT

An intelligent detection method for a flower opening degree in jasmine tea scenting is applied to jasmine flower opening degree detection and to solve the problems of low efficiency and low detection accuracy of manual detection. The method includes the following steps: S1, acquisition of data and creation of data sets; S2, construction of augmented data sets and division of a training set and a validation set; S3, construction of a yolo-v8 based improved detection model for jasmine flowers of different opening degrees; S4, training and validation of the improved detection model for jasmine flowers of different opening degrees; and S5, identification of a jasmine flower to be detected. The method avoids time-consuming and laborious, and inefficient manual detection, liberates the labor force, reduces the cost input, and has high practicability.

### CROSS REFERENCE TO THE RELATED APPLICATIONS

This application is based upon and claims priority to Chinese Patent Application No. 202410783847.5, filed on Jun. 18, 2024, the entire contents of which are incorporated herein by reference.

### TECHNICAL FIELD

The present disclosure relates to the field of detection technology, and in particular, to an intelligent detection method for a flower opening degree in jasmine tea scenting.

### BACKGROUND

Jasmine tea is reprocessed tea unique in China and is deeply loved by consumers because of its distinct aroma quality and health care effect for the human body. Currently, there may be problems of high labor intensity, low level of hygiene, poor processing conditions, and the like during the scenting of jasmine tea. Manual detection is time-consuming and laborious, and inefficient. With the development of the computer industry, the traditional agriculture is developing towards intellectualization, which provides a direction for the upgrading of the jasmine tea industry, and the identification of the jasmine flower opening degree can provide necessary technical support and intelligent solutions for the jasmine flower growing process. The use of intelligent equipment in the identification process is conducive to shortening the time and improving the effect and accuracy in the artificial identification process. However, this identification method has a high equipment requirement and usually requires assistance of a high-resolution camera, increasing the cost and leading to a long benefit period. As the information network becomes increasingly developed, the problem is not limited to small sample data analysis, and instead, will be mass big data analysis. Deep learning, belonging to the mixing development field of computer science, statistics, and data science and technology, has been playing a leading role in the biometric flower feature identification. By introducing deep learning into the identification of the jasmine flower opening degree, the features of jasmine flowers of different opening degrees are extracted by utilizing deep learning so as to achieve stronger and more accurate data expression capability, thus achieving the purpose of identifying jasmine flowers of different opening degrees.

### SUMMARY

An objective of the present disclosure is to provide an intelligent detection method for a flower opening degree in jasmine tea scenting, which is applied to jasmine flower opening degree detection and to solve the problems of low efficiency and low detection accuracy of manual detection.

The technical solution adopted to solve the technical problems of the present disclosure is as follows: an intelligent detection method for a flower opening degree in jasmine tea scenting includes the following steps:
S1, acquisition of data and creation of data sets:
acquiring and preprocessing jasmine flower image data of different opening degrees, and marking, using marking software, jasmine flowers in the image data as open and not open, thereby obtaining classified jasmine flower data sets;
S2, construction of augmented data sets and division of a training set and a validation set:
performing data augmentation on the classified jasmine flower data sets to establish the augmented data sets, and dividing the augmented data sets into the training set and the validation set;
S3, construction of a yolo-v8 based improved detection model for jasmine flowers of different opening degrees:
selecting yolo-v8 as a basic network model, the yolo-v8 including four parts: Input, Backbone, Neck, and Head; then integrating bi-level routing attention (BRA) into the yolo-v8 model, integrating a generalized feature pyramid network (GFPN) into the yolo-v8 model, adding a detector head to the yolo-v8 model, and establishing the yolo-v8 based improved detection model for jasmine flowers of different opening degrees;
S4, training and validation of the improved detection model for jasmine flowers of different opening degrees:
training the yolo-v8 based improved detection model for jasmine flowers of different opening degrees constructed in step S3 with the training set obtained in step S2, and validating the yolo-v8 based improved detection model for jasmine flowers of different opening degrees with the validation set, thereby obtaining a validated yolo-v8 based improved detection model for jasmine flowers of different opening degrees; and
S5, identification of a jasmine flower to be detected:
identifying an opening degree of the jasmine flower to be detected using the yolo-v8 based improved detection model for jasmine flowers of different opening degrees finally obtained in step S4, thereby obtaining an identification result.

Further, image extraction is performed on images of the jasmine flowers of different opening degrees with a plurality of sets of different resolutions to obtain image data at the plurality of sets of different resolutions such that an optimal detection resolution is set in subsequent testing; and a segment anything model (SAM) is accessed in the marking software to assist with marking.

Further, in step S4, the jasmine flower to be detected is compared with the trained yolo-v8 based improved detection model for jasmine flowers of different opening degrees to identify whether the jasmine flower is open or not open.

Further, in step S2, the data augmentation is achieved by using CutMix, Mosaic, and random flipping.

Further, each time when the CutMix data augmentation is performed, one image is selected from a jasmine flower image data set, and image overlaying and stitching is performed by the CutMix; each time when the Mosaic data augmentation is performed, four images are selected from the jasmine flower image data set, and image stitching is performed by the Mosaic; image data after the CutMix data augmentation and image data after the Mosaic data augmentation are merged with jasmine flower image data not subjected to the CutMix data augmentation and the Mosaic data augmentation, and then data augmentation is performed by using the random flipping to obtain the augmented data sets.

Further, in step S2, a ratio of the training set to the validation set is 8:2.

Further, in step S3, the GFPN is obtained by performing new path fusion on an FPN structure and then performing layer-skipping and cross-scale connection.

Further, in step S3, a universal visual transformer BiFormer is constructed based on a bi-level routing attention (BRA) module; overlap patch embedding is utilized at a first stage, and a block merging module is utilized at second to fourth stages to reduce an input spatial resolution; meanwhile, a number of channels is increased, and then continuous BiFormer blocks are utilized for feature transformation.

Further, the jasmine flower image data of different opening degrees is acquired using an acquisition device; and the acquisition device includes a camera obscura with an industrial camera and a near-infrared camera therein.

Further, the camera obscura includes a frame that is of a cuboid-shaped frame structure and light shielding plates that are disposed on five side faces of the frame.

The present disclosure has the following beneficial effects: the method of the present disclosure avoids time-consuming and laborious, and inefficient manual detection, liberates the labor force, reduces the cost input, and has high practicability. A bi-level routing attention (BRA) mechanism is introduced into a basic network model Backbone to improve the model detection accuracy. A lightweight, and deep and large GFPN module is introduced into the Neck to replace the original FPN module such that the problems of only focusing and feature extraction on multi-scale features of different resolutions extracted from the backbone network by the FPN, and lack of intra-block connection are solved. A plurality of detector heads are integrated into the model, thereby improving the segmentation accuracy.

### BRIEF DESCRIPTION OF THE DRAWINGS

FIG. 1 is a front view of a detection device of the present disclosure;

FIG. 2 is a left view of the detection device of the present disclosure;

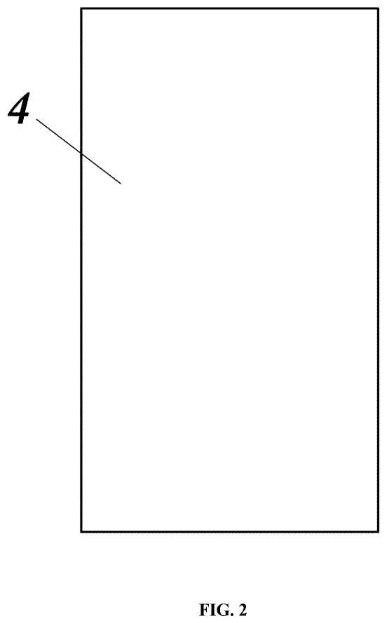

FIG. 3 is a flowchart of a detection method of the present disclosure;

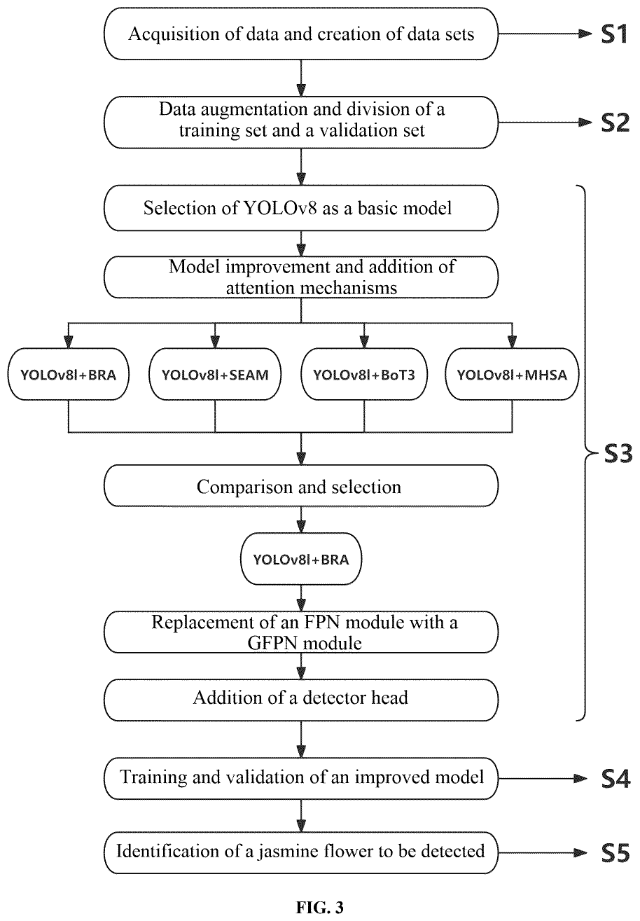

FIG. 4 is a diagram showing detection grading results of the present disclosure;

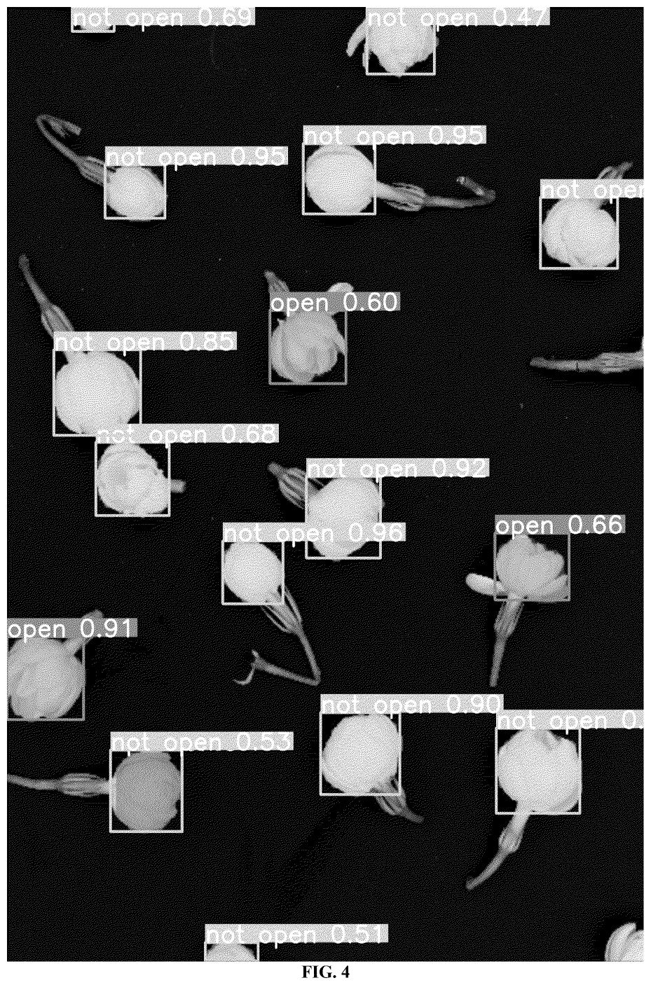

FIG. 5 is a diagram showing experimental results after addition of an attention mechanism to a basic network; and

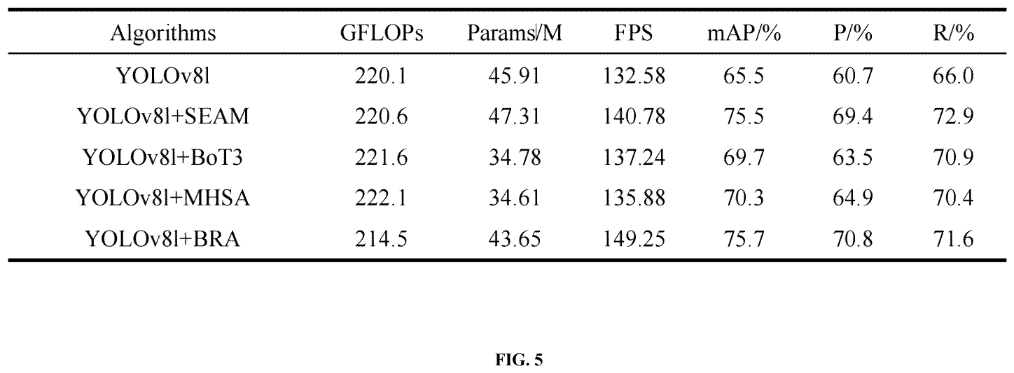

FIG. 6 is a diagram showing detection grading performance of an improved model.

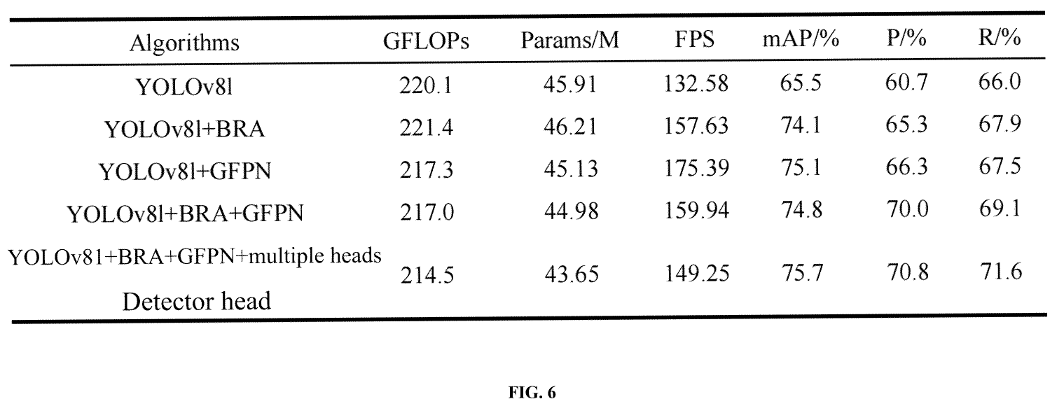

List of Reference Numerals: 1—frame, 2—industrial camera, 3—near-infrared camera, and 4—light shielding plate.

### DETAILED DESCRIPTION OF THE EMBODIMENTS

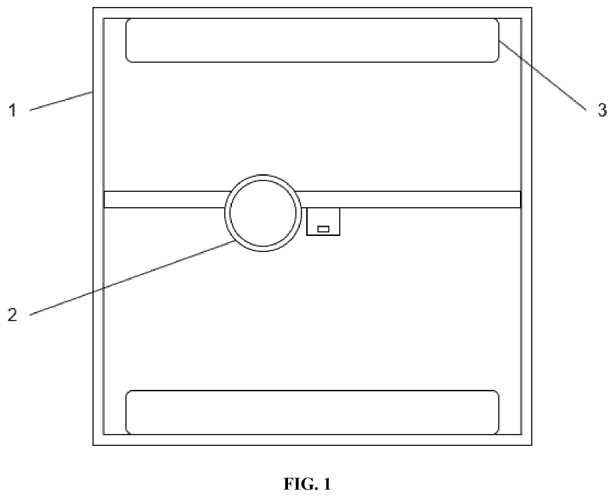

As shown in FIG. 1, a detection device of the present disclosure includes a frame 1, an industrial camera 2, a near-infrared camera 3, and a light shielding plate 4. The frame 1 is of a skeleton structure made of an aluminum alloy. The light shielding plates 4 are disposed on five side faces of the frame 1 for shielding natural light. The frame 1 and the light shielding plates 4 constitute a camera obscura. The industrial camera 2 and the near-infrared camera 3 are disposed inside the frame 1. The industrial camera 2 is configured to acquire jasmine flower image data, and the near-infrared camera 3 is configured to acquire jasmine flower moisture data.

Using the detection device of the present disclosure, an intelligent detection method for a flower opening degree in jasmine tea scenting in the present disclosure includes the following steps.

S1, data is acquired and data sets are created.

Jasmine flower image data of different opening degrees is acquired using the industrial camera 2, and preprocessed, and jasmine flowers in the image data are marked, using marking software, as open and not open, thereby obtaining classified jasmine flower data sets. Image extraction is performed on images of the jasmine flowers of different opening degrees with a plurality of sets of different resolutions to obtain image data at the plurality of sets of different resolutions such that an optimal detection resolution is set in subsequent testing; and a segment anything model (SAM) is accessed in the marking software to assist with marking. For example:
S1.1, 1500 pieces of jasmine flower image data of different opening degrees are obtained by the industrial camera 2.
S1.2, the obtained image data is marked with special-shaped boxes using ISAT-SAM software to obtain a tag file.
S2, augmented data sets are constructed and divided into a training set and a validation set.

Data augmentation is performed on the classified jasmine flower data sets to establish the augmented data sets, and the augmented data sets are divided into the training set and the validation set.

The data augmentation is achieved by using CutMix, Mosaic, and random flipping. Each time when the CutMix data augmentation is performed, one image is selected from a jasmine flower image data set, and image overlaying and stitching is performed by the CutMix; each time when the Mosaic data augmentation is performed, four images are selected from the jasmine flower image data set, and image stitching is performed by the Mosaic; image data after the CutMix data augmentation and image data after the Mosaic data augmentation are merged with jasmine flower image data not subjected to the CutMix data augmentation and the Mosaic data augmentation, and then data augmentation is performed by using the random flipping to obtain the augmented data sets. A ratio of the training set to the validation set is 8:2.
S3, a yolo-v8 based improved detection model for jasmine flowers of different opening degrees is constructed.

yolo-v8 is selected as a basic network model, the yolo-v8 including four parts: Input, Backbone, Neck, and Head. Then, bi-level routing attention (BRA) is integrated into the yolo-v8 model. A generalized feature pyramid network (GFPN) is integrated into the yolo-v8 model. A detector head is added to the yolo-v8 model (the original yolo-v8 model has only three detector heads, the heights and widths of which are 20×20, 40×40, and 80×80, respectively, and thus cannot meet the jasmine flower detection requirement; therefore, a 160×160 detector head is introduced at the head position to improve the detection capability for objects of different scales). The yolo-v8 based improved detection model for jasmine flowers of different opening degrees is then constructed.

The GFPN is obtained by performing new path fusion on an FPN structure and then performing layer-skipping and cross-scale connection. The bi-level routing attention (BRA) is integrated into the yolo-v8 model. A universal visual transformer BiFormer is constructed based on a BRA module. Overlap patch embedding is utilized at a first stage, and a block merging module is utilized at second to fourth stages to reduce an input spatial resolution; meanwhile, a number of channels is increased, and then continuous BiFormer blocks are utilized for feature transformation.

The present disclosure adopts a comparative experimental method to obtain the attention mechanism having the best experimental effect on the BRA of the present disclosure. The specific experimental method is as follows.
(1) Attention mechanisms SEAM, BoT3, MHSA, and BRA are added to the Backbone of the basic network model yolo-v8, the experimental effects are compared, and the attention mechanism BRA having the best experimental effect is selected.
(2) A lightweight, and deep and large GFPN module is introduced into the Neck to replace the original FPN module such that the problems of only focusing and feature extraction on multi-scale features of different resolutions extracted from the backbone network by the FPN, and lack of intra-block connection are solved.
(3) A plurality of detector heads are integrated into the model, thereby improving the segmentation accuracy.

S4, the improved detection model for jasmine flowers of different opening degrees is trained and validated.

The yolo-v8 based improved detection model for jasmine flowers of different opening degrees constructed in step S3 is trained with the training set obtained in step S2, and validated with the validation set, thereby obtaining a validated yolo-v8 based improved detection model for jasmine flowers of different opening degrees. The training mode is as follows: CUDA software is adopted for acceleration, an Adam optimizer is adopted for model optimization, and a cosine annealing algorithm is adopted to dynamically adjust the model and train the learning rate. The model is trained for 300 epochs, thereby obtaining an improved jasmine flower grading model. The jasmine flower to be detected is compared with the trained yolo-v8 based improved detection model for jasmine flowers of different opening degrees to identify whether the jasmine flower is open or not open.

S5, a jasmine flower to be detected is identified.

An opening degree of the jasmine flower to be detected is identified using the yolo-v8 based improved detection model for jasmine flowers of different opening degrees finally obtained in step S4, thereby obtaining an identification result. Specific steps are as follows.
S5.1, a weight and parameters of the trained yolo-v8 based improved detection model for jasmine flowers of different opening degrees are loaded.
S5.2, the acquired image data is input to the yolo-v8 based improved detection model for jasmine flowers of different opening degrees for testing.
S5.3, a segmentation and detection result is obtained.

The intelligent detection method for a flower opening degree in jasmine tea scenting in the present disclosure avoids time-consuming and laborious, and inefficient manual detection, liberates the labor force, reduces the cost input, and has high practicability. A bi-level routing attention (BRA) mechanism is introduced into a basic network model Backbone to improve the model detection accuracy. A lightweight, and deep and large GFPN module is introduced into the Neck to replace the original FPN module such that the problems of only focusing and feature extraction on multi-scale features of different resolutions extracted from the backbone network by the FPN, and lack of intra-block connection are solved. A plurality of detector heads are integrated into the model, thereby improving the segmentation accuracy.

What is claimed is:

1. An intelligent detection method for a flower opening degree in jasmine tea scenting, comprising the following steps:
S1, acquisition of data and creation of data sets:
acquiring and preprocessing jasmine flower image data of different opening degrees, and marking, using marking software, jasmine flowers in the jasmine flower image data as open and not open, thereby obtaining classified jasmine flower data sets;
S2, construction of augmented data sets and division of a training set and a validation set:
performing data augmentation on the classified jasmine flower data sets to establish the augmented data sets, and dividing the augmented data sets into the training set and the validation set;
S3, construction of a yolo-v8 based improved detection model for jasmine flowers of different opening degrees:
selecting a yolo-v8 model as a basic network model, then integrating bi-level routing attention (BRA) into the yolo-v8 model, integrating a generalized feature pyramid network (GFPN) into the yolo-v8 model, adding a detector head to the yolo-v8 model, and establishing the yolo-v8 based improved detection model for the jasmine flowers of different opening degrees;
S4, training and validation of the improved detection model for the jasmine flowers of different opening degrees:
training the yolo-v8 based improved detection model for the jasmine flowers of different opening degrees constructed in step S3 with the training set obtained in step S2, and validating the yolo-v8 based improved detection model for the jasmine flowers of different opening degrees with the validation set, thereby obtaining a validated yolo-v8 based improved detection model for the jasmine flowers of different opening degrees; and
S5, identification of a jasmine flower to be detected:
identifying an opening degree of the jasmine flower to be detected using the yolo-v8 based improved detection model for the jasmine flowers of different opening degrees finally obtained in step S4, thereby obtaining an identification result.

2. The intelligent detection method according to claim 1, wherein in step S1, image extraction is performed on images of the jasmine flowers of different opening degrees with a plurality of sets of different resolutions to obtain image data at the plurality of sets of different resolutions such that an optimal detection resolution is set in subsequent testing; and a segment anything model (SAM) is accessed in the marking software to assist with marking.

3. The intelligent detection method according to claim 1, wherein in step S4, the jasmine flower to be detected is compared with the trained yolo-v8 based improved detection model for the jasmine flowers of different opening degrees to identify whether the jasmine flower is open or not open.

4. The intelligent detection method according to claim 1, wherein in step S2, the data augmentation is achieved by using CutMix, Mosaic, and random flipping.

5. The intelligent detection method according to claim 4, wherein each time when CutMix data augmentation is performed, one image is selected from a jasmine flower image data set, and image overlaying and stitching is performed by the CutMix; each time when Mosaic data augmentation is performed, four images are selected from the jasmine flower image data set, and image stitching is performed by the Mosaic; image data after the CutMix data augmentation and image data after the Mosaic data augmentation are merged with jasmine flower image data not subjected to the CutMix data augmentation and the Mosaic data augmentation, and then data augmentation is performed by using the random flipping to obtain the augmented data sets.

6. The intelligent detection method according to claim 5, wherein in step S2, a ratio of the training set to the validation set is 8:2.

7. The intelligent detection method according to claim 1, wherein in step S3, the GFPN is obtained by performing new path fusion on an FPN structure and then performing layer-skipping and cross-scale connection.

8. The intelligent detection method according to claim 7, wherein in step S3, a universal visual transformer BiFormer is constructed based on a bi-level routing attention (BRA) module; overlap patch embedding is utilized at a first stage, and a block merging module is utilized at second to fourth stages to reduce an input spatial resolution; meanwhile, a number of channels is increased, and then continuous BiFormer blocks are utilized for feature transformation.

9. The intelligent detection method according to claim 1, wherein the jasmine flower image data of different opening degrees is acquired using an acquisition device; and the acquisition device comprises a camera obscura, wherein an industrial camera and a near-infrared camera are provided in the camera obscura.

10. The intelligent detection method according to claim 9, wherein the camera obscura comprises a frame and light shielding plates, wherein the frame is of a cuboid-shaped frame structure, and the light shielding plates are disposed on five side faces of the frame.
